(19) United States
(12) Patent Application Publication
(10) Pub. No.: US 2021/0185132 A1
(43) Pub. Date: Jun. 17, 2021

(54) SIP INFORMATION ANALYSIS METHOD AND DEVICE, SERVER, AND MEDIUM

(71) Applicant: PING AN TECHNOLOGY (SHENZHEN) CO., LTD., Shenzhen, Guangdong (CN)

(72) Inventors: Xiukai ZHANG, Shenzhen (CN); Enyan FAN, Shenzhen (CN); Lei QIAO, Shenzhen (CN); Guangwei LIU, Shenzhen (CN)

(21) Appl. No.: 16/090,589

(22) PCT Filed: Jan. 31, 2018
(86) PCT No.: PCT/CN2018/074842

§ 371 Date: Oct. 1, 2018

(30) Foreign Application Priority Data
Aug. 30, 2017 (CN) 201710761480.7

(51) Int. Cl. H04L 29/08; H04L 29/06

(52) U.S. Cl. CPC H04L 67/146; H04L 65/1006; H04L 69/22

(57) ABSTRACT

The present application is applicable to the technical field of communication, and provides a session initiation protocol (SIP) information analysis method and device, a server, and a medium. The method includes adding a header field identifier to each of SIP messages; performing packet capture on each of the SIP messages to respectively obtain a first SIP message and a second SIP message when each of the SIP messages passes through an external network switch and an internal network switch; performing matching identification on each of the first SIP messages and each of the second SIP messages according to the header field identifier of each of the SIP messages, to determine a first SIP message and a second SIP message having the same header field identifier; and analyzing the SIP messages according to the first SIP message and the second SIP message having the same header field identifier. Through the above SIP information analysis method and the server, SIP messages having problems in the cross-domain process can be detected, and the SIP messages with the problems can also be analyzed.

The present application claims priority of Chinese Patent Application No. 201710761480.7, entitled “SESSION INITIATION PROTOCOL (SIP) INFORMATION ANALYSIS METHOD AND SERVER”, filed with China Patent Office on Aug. 30, 2017, the content of which is incorporated herein by reference in its entirety.

### TECHNICAL FIELD

The present application relates to the technical field of data processing, and particularly to a session initiation protocol (SIP) information analysis method and a device, a server, and a medium.

### BACKGROUND

SIP (session initiation protocol)-based mobile video services are limited by a mobile terminal network and a transit device during the network transmission. SIP messages may be lost or abnormally processed. At present, SIP messages cannot be identified. If a problem occurs to an SIP message in the cross-domain process, the SIP message having the problem cannot be detected. The fuzzy analysis can only be performed with respect to extension and time, and the cause of the SIP problem cannot be analyzed.

### SUMMARY

In view of this, an embodiment of the present application provides an SIP information analysis method and a server, to solve the problems in the prior art that when a problem occurs to an SIP message in the cross-domain process, the SIP message having the problem cannot be detected and the cause of the SIP problem cannot be analyzed.

A first aspect of an embodiment of the present application provides an SIP information analysis method, which includes:

adding a unique header field identifier to each of SIP messages, such that each of the SIP message is uniquely identifiable;

performing packet capture on each of the SIP messages to obtain a first SIP message when the each of the SIP messages passes through an external network switch;

performing preset processing on each of the SIP messages before each of the SIP messages passes through an internal network switch, and performing packet capture on each of the SIP messages again to obtain a second SIP message when the each of the SIP messages passes through the internal network switch;

performing matching identification on each of the first SIP messages and each of the second SIP messages according to the header field identifier of each of the SIP messages, to determine a first SIP message and a second SIP message having the same header field identifier; and

analyzing the SIP messages according to the first SIP message and the second SIP message having the same header field identifier.

A second aspect of an embodiment of the present application provides an SIP information analysis device, which includes:

an identifier adding module, configured to add a unique header field identifier to each of SIP messages, such that each of the SIP message is uniquely identifiable;

a packet capture module, configured to perform packet capture on each of the SIP messages to obtain a first SIP message when the each of the SIP messages passes through an external network switch;

a packet recapture module, configured to perform preset processing on each of the SIP messages before the each of the SIP messages passes through an internal network switch, and perform packet capture on each of the SIP messages again to obtain a second SIP message when the each of the SIP messages passes through the internal network switch;

a matching module, configured to perform matching identification on each of the first SIP messages and each of the second SIP messages according to the header field identifier of each of the SIP messages, and determine a first SIP message and a second SIP message having the same header field identifier; and

an analysis module, configured to analyze the SIP messages according to the first SIP message and the second SIP message having the same header field identifier.

A third aspect of an embodiment of the present application provides a server, which includes a memory and a processor, the memory being configured to store therein computer readable instructions executable on the processor, and the processor implementing the following steps when executing the computer readable instructions:

adding a unique header field identifier to each of SIP messages, such that each of the SIP message is uniquely identifiable;

performing packet capture on each of the SIP messages to obtain a first SIP message when the each of the SIP messages passes through an external network switch;

performing preset processing on each of the SIP messages before each of the SIP messages passes through an internal network switch, and performing packet capture on each of the SIP messages again to obtain a second SIP message when the each of the SIP messages passes through the internal network switch;

performing matching identification on each of the first SIP messages and each of the second SIP messages according to the header field identifier of each of the SIP messages, to determine a first SIP message and a second SIP message having the same header field identifier; and

analyzing the SIP messages according to the first SIP message and the second SIP message having the same header field identifier.

A fourth aspect of an embodiment of the present application provides a computer readable storage medium, having stored thereon computer readable instructions, where when the computer readable instructions are executed by at least one processor, the following steps are implemented:

adding a unique header field identifier to each of SIP messages, such that each of the SIP message is uniquely identifiable;

performing packet capture on each of the SIP messages to obtain a first SIP message when the each of the SIP messages passes through an external network switch;

performing preset processing on each of the SIP messages before each of the SIP messages passes through an internal network switch, and performing packet capture on each of the SIP messages again to obtain a second SIP message when the each of the SIP messages passes through the internal network switch;

performing matching identification on each of the first SIP messages and each of the second SIP messages according to the header field identifier of each of the SIP messages, to determine a first SIP message and a second SIP message having the same header field identifier; and

analyzing the SIP messages according to the first SIP message and the second SIP message having the same header field identifier.

Compared with the prior art, an embodiment of the present application has the beneficial effects: according to the embodiment of the present application, a unique header field identifier enabling each of SIP messages to be uniquely identified is added to each of the SIP messages, packet capture is respectively performed on each of the SIP messages passing through an external network switch and an internal network switch, and a first SIP message and a second SIP message having the same header field identifier are determined according to the header field identifier of each of the SIP messages, so that each of the SIP messages can be analyzed according to the first SIP message and the second SIP message having the same header field identifier; SIP messages that have problems in the cross-domain process can be detected, and the SIP messages that have the problems can also be analyzed to obtain the source of the problems and carry out the corresponding processing.

### BRIEF DESCRIPTION OF DRAWINGS

In order to illustrate the technical solutions in the embodiments of the present application more clearly, the accompanying drawings used in description of the embodiments or the prior art will be briefly described below. Apparently, the accompanying drawings in the following description are only some embodiments of the present application. For those of ordinary skills in the art, other accompanying drawings may also be obtained without creative labor.

FIG. 1 is a flowchart of an SIP information analysis method according to an embodiment of the present application;

FIG. 2 is an implementation flowchart of an embodiment of step S105 in FIG. 1;

FIG. 3 is an implementation flowchart of another embodiment of step S105 in FIG. 1;

FIG. 4 is a running environment schematic diagram of an SIP information analysis program according to an embodiment of the present application; and

FIG. 5 is a program module diagram of an SIP information analysis program 400 according to an embodiment of the present application.

### DETAILED DESCRIPTION OF EMBODIMENTS

In the following description, for the objective of description rather than limitation, specific details such as specific system architectures and technologies are set forth, in order to thoroughly understand the embodiments of the present application. However, it will be apparent to those skilled in the art that the present application may also be implemented in other embodiments without these specific details. In other instances, detailed descriptions of well-known systems, devices, circuits, and methods are omitted, lest unnecessary details hinder the description of the present application.

In order to explain the technical solutions of the present application, the following description will be made by way of specific embodiments.

The technical terms “first”, “second” and the like in the specification and claims of the embodiments of the present application are used to distinguish similar objects, and are not necessarily used to describe a specific order of precedence. It should be understood that the data so used may be interchangeable where appropriate, so that the embodiments of the present application described herein can be implemented in a sequence other than those illustrated or described herein. In addition, the terms “include” and “be provided with” and any variants thereof are intended to cover those non-exclusive inclusions. For example, processes, methods, systems, products, or devices that include a series of steps or units are not necessarily limited to those steps or units that are explicitly listed, and may include other steps or units not explicitly listed or inherent to such processes, methods, systems, products or devices.

It should be understood that the term “include(comprise)”, when used in the specification and the appended claims, is used to indicate the presence of the described features, integers, steps, operations, elements and/or components, but does not exclude the existence or addition of one or more other features, integers, steps, operations, elements, components, and/or collections thereof.

It should also be understood that the terms used in the specification of the present application are only for the objective of describing specific embodiments and are not intended to limit the present application. As used in the specification and the appended claims of the present application, unless the context clearly indicates otherwise, singular forms “a/an”, “one” and “the” are intended to include plural forms.

It should be further understood that the term “and/or” used in the specification and the appended claims of the present application means any combination and all possible combinations of one or more of the associated listed items, and includes these combinations.

As used in this specification and the appended claims, the term_{if} can be interpreted as “when” or “once” or “in response to determining” or “in response to detecting” depending on the context. Similarly, the phrase “if determined” or “if detected [the described condition or event]” may be interpreted, depending on the context, to mean “once determined” or “in response to determining” or “once detected [the described condition or event] or “in response to detecting [the described condition or event]”.

In order to explain the technical solutions of the present application, the following description will be made by way of specific embodiments.

### Embodiment 1

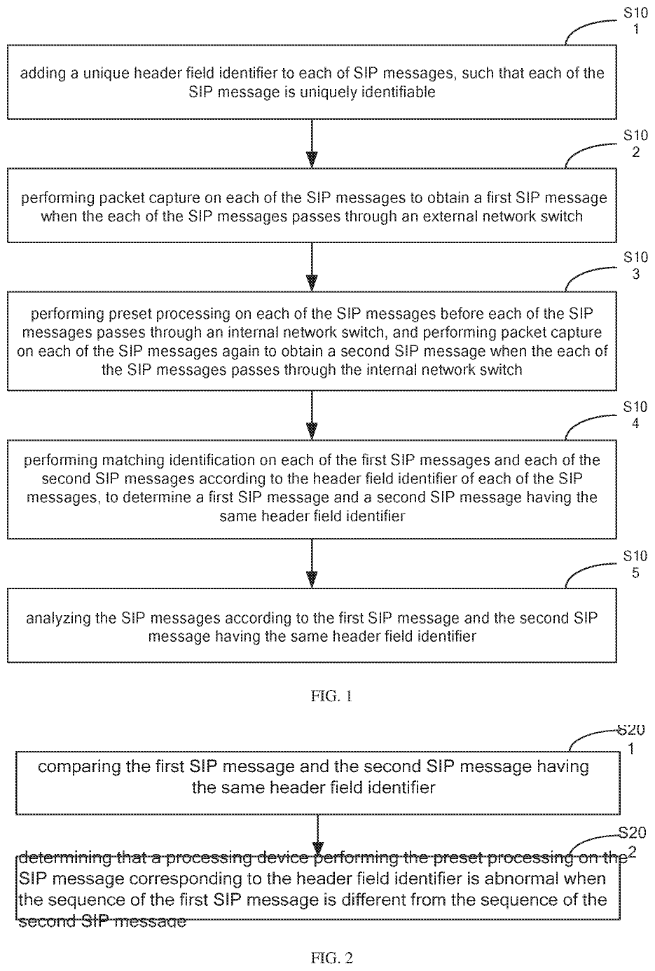

FIG. 1 illustrates an implementation flowchart of an SIP information analysis method according to Embodiment 1 of the present application, detailed below:

Step S101: adding a unique header field identifier to each of SIP messages, such that each of the SIP message is uniquely identifiable.

In this case, SIP-based mobile video services are limited by the mobile terminal network and a transit device during the network transmission. SIP messages may be lost or abnormally processed. Currently, due to the composition of the SIP message, after the SIP message crosses a domain, the SIP message cannot be determined according to information in the SIP message. In this step, each of the SIP messages is uniquely identified by adding a unique header field identifier to each of the SIP messages.

In an embodiment, step S101 may specifically include: determining a header field identifier of each of the SIP messages according to a unique identifier of a terminal device that generates each of the SIP messages and a media access control (MAC) address of each of the SIP messages, and adding the header field identifier into the corresponding SIP message.

Specifically, the unique identifier of the terminal device that generates each of the SIP messages may be a universally unique identifier (UUID), which is related to the terminal device that generates the SIP messages, and may be, for example, a UUID of a calling terminal or a UUID of a called terminal.

The MAC address is used to define the location of a network device, which is determined by a network card and is fixed. In this embodiment, the MAC address is determined by the network card of the terminal device that generates each of the SIP messages.

For example, if the SIP message is generated and sent by the calling terminal, the header field identifier of the SIP message may be determined according to the unique identifier of the calling terminal that generates each of the SIP messages and the MAC address of the calling terminal that generates the SIP message, and the header field identifier is added to a header field of the SIP message.

As an implementable mode, a hash value of each of SIP messages may be determined by hash calculation according to the unique identifier of the terminal device that generates each of the SIP messages and the MAC address of each of the SIP messages, and the hash value of the SIP message serves as the header field identifier of the SIP message.

For example, if the SIP message is generated and sent by the calling terminal, the hash value of each of the SIP messages may be determined by hash calculation according to the unique identifier of the calling terminal that generates each of the SIP messages and the MAC address of the calling terminal that generates each of the SIP messages, and the hash value of the SIP message serves as the header field identifier of the SIP message and is added into the header field of the SIP message.

In addition, the header field identifier of the SIP message may also be determined according to the unique identifier of the calling terminal that generates each of the SIP messages, the MAC address of the calling terminal that generates the SIP message and the generation time of each of the SIP messages, and the header field identifier is added to the header field of the SIP message.

In this embodiment, each header field identifier corresponds to an ID of a terminal device that generates an SIP message, and one terminal device ID may correspond to multiple header field identifiers. Therefore, through a header field identifier, an SIP message and a terminal device corresponding to the header field identifier can be uniquely determined.

Step S102: performing packet capture on each of the SIP messages to obtain a first SIP message when the each of the SIP messages passes through an external network switch;

It can be understood that after passing through the external network switch, the SIP message enters an internal network, such as an internal network of Ping An Group. At this time, each of SIP messages that enters the internal network through the external network switch needs to be subject to packet capture, to obtain a first SIP message including a header field identifier. In this case, packet capture refers to operations of intercepting, resending, editing, and transferring data packets transmitted and received by the network transmission, and can be implemented by a dedicated software tool.

Here, the first SIP message is obtained by performing packet capture on the SIP message, the header field part of the first SIP message includes the header field identifier set in step S101, and the header field identifier does not change during the packet capture process, thereby ensuring the uniqueness and accuracy of the header field identifier.

Step S103: performing preset processing on each of the SIP messages before each of the SIP messages passes through an internal network switch, and performing packet capture on each of the SIP messages again to obtain a second SIP message when the each of the SIP messages passes through the internal network switch.

After each of the SIP messages having undergone packet capture enters the internal network, the SIP message is subject to various preset processing, such as message relay and information conversion. Specifically, the corresponding preset processing may be performed according to the type of the SIP message and related information included in each of the SIP messages.

For example, an SIP message may include a request message and a response message. The request message is a message sent by an SIP client (namely a calling terminal that generates the SIP message) to a server in order to activate a specific operation, and may specifically include a session request message, a session termination request message, and the like. For the session request message, a session request of the SIP client is sent to a target terminal according to an identifier of the target terminal (also referred to as the called terminal) in the session request message.

The response message is used to respond to the request message, and indicates a success or failure state of a call. Correspondingly, the response message may include success response information of the session request, failure response information of the session request, and the like.

Specifically, the SIP message may be composed of a start line, a message header, a blank line that marks the ending of the message header, and a message body serving as an option. The start line of the SIP message is divided into a request line and a status line. In this case, the request line is the start line of the request message, and the status line is the start line of the response message. It can be seen that the request message includes a request line, a message header, a blank line, and a message body; and the response message includes a status line, a message header, a blank line, and a message body.

Both the request message and the response message include an SIP message header field and an SIP message body field. The SIP message header is mainly used to indicate an initiator and a receiver of this message, and basic information such as how many jumps; the SIP message body is mainly used to describe a specific implementation mode of the session; and a command line and each parameter line are distinguished by a line break.

It can be understood that after the preset processing, the SIP message needs to pass through the internal network switch and the external network switch to reach the target terminal (for example, the called terminal). At this time, each of the SIP messages passing through the internal network switch needs to be subject to packet capture again to obtain a second SIP message including a header field identifier.

Here, the second SIP message is obtained by performing packet capture on the SIP message after the preset processing, the header field part of the second SIP message includes the header field identifier set in step S101, and the header field identifier does not change during the two packet capture processes and the preset processing process, thereby ensuring the uniqueness and accuracy of the header field identifier.

Step S104: performing matching identification on each of the first SIP messages and each of the second SIP messages according to the header field identifier of each of the SIP messages, to determine a first SIP message and a second SIP message having the same header field identifier; and

In this case, the header field identifier does not change during the two packet capture processes and the preset processing process. That is, for the same SIP message, the first SIP message obtained by performing packet capture on the SIP message for the first time contains the header field identifier of the SIP message, and the second SIP message obtained by performing the packet capture on the SIP message for the second time after the preset processing also includes the header field identifier of the SIP message. Therefore, matching identification can be performed on each of the first SIP messages and each of the second SIP messages according to the header field identifier of each of the SIP messages, to determine a first SIP message and a second SIP message having the same header field identifier, namely messages obtained by packet capture based on the same SIP message.

It can be understood that, after the first SIP message and the second SIP message having the same header field identifier are identified according to the header field identifier set in step S101, the corresponding SIP message may be analyzed according to the first SIP message and the second SIP message. It should be noted that the first SIP message and the second SIP message having the same header field identifier may be multiple pairs, and each pair of the first SIP message and the second SIP message having the same header field identifier corresponds to one SIP message.

Step S105: analyzing the SIP messages according to the first SIP message and the second SIP message having the same header field identifier.

In this embodiment, the corresponding SIP message is analyzed according to the first SIP message and the second SIP message having the same header field identifier identified in step S104.

Referring to FIG. 2, in an embodiment, the step of analyzing the SIP messages according to the first SIP message and the second SIP message having the same header field identifier may specifically include the following process:

Step S201: comparing the first SIP message and the second SIP message having the same header field identifier.

In this case, the first SIP message is obtained by performing packet capture for the first time on the SIP message entering the external network switch, and the second SIP message is obtained by performing packet capture for the second time on the SIP message having undergone the preset processing, so that the first SIP message and the second SIP message have the same sequence as the SIP message.

In this embodiment, the step of comparing the first SIP message and the second SIP message having the same header field identifier may be: determining by comparison whether the sequences of the first SIP message and the second SIP message having the same header field identifier are the same.

Step S202, determining that a processing device performing the preset processing on the SIP message corresponding to the header field identifier is abnormal when the sequence of the first SIP message is different from the sequence of the second SIP message.

In this case, when the processing device performs the preset processing on the SIP message, it may cause the sequence of the SIP message to be different from the sequence of the SIP message having undergone the preset processing, that is, processing abnormality occurs. Therefore, when the sequence of the first SIP message is different from the sequence of the second SIP message, it can be determined that a processing device performing the preset processing on the SIP message corresponding to the header field identifier is abnormal. For example, the corresponding processing device can be found by looking up the to-be-performed preset processing that have the corresponding information in the SIP message.

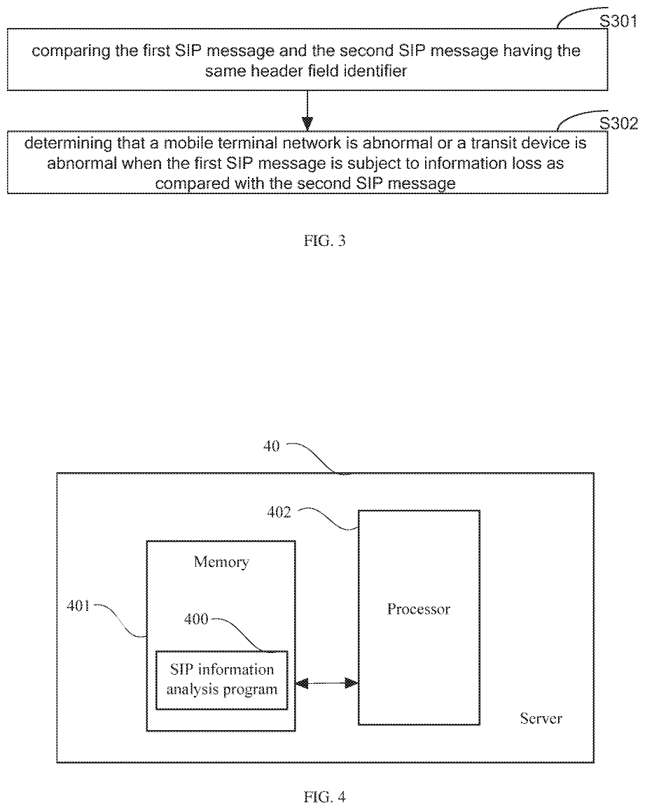

Referring to FIG. 3, in another embodiment, the step of analyzing the SIP messages according to the first SIP message and the second SIP message having the same header field identifier may specifically include the following process:

Step S301: comparing the first SIP message and the second SIP message having the same header field identifier.

In this embodiment, the step of comparing the first SIP message and the second SIP message having the same header field identifier may be: determining by comparison whether the first SIP message and the second SIP message having the same header field identifier are subject to information loss.

Step S302: determining that a mobile terminal network is abnormal or a transit device is abnormal when the first SIP message is subject to information loss as compared with the second SIP message.

In this case, when the mobile terminal network is abnormal or the transit device is abnormal, the second SIP message may be subject to information loss relative to the first SIP message. Therefore, when it is detected that the first SIP message is subject to information loss as compared with the second SIP message, it can be determined that the mobile terminal network is abnormal or the transit device is abnormal. For example, the mobile terminal ID and the transit device ID can be searched for through the corresponding information in the SIP message.

In the aforementioned SIP information analysis method, a unique header field identifier enabling each of the SIP messages to be uniquely identified is added to each of SIP messages, packet capture is respectively performed on each of the SIP messages passing through an external network switch and an internal network switch, and a first SIP message and a second SIP message having the same header field identifier are determined according to the header field identifier of each of the SIP messages, so that each of the SIP messages can be analyzed according to the first SIP message and the second SIP message having the same header field identifier; SIP messages that have problems in the cross-domain process can be detected, and the SIP messages that have the problems can also be analyzed to obtain the source of the problems and carry out the corresponding processing.

It should be understood that the size of the serial numbers of the steps in the above embodiments does not mean the order of execution. The order of execution of each process should be determined by its function and internal logic, and should not be construed as limiting the implementation process of the embodiments of the present application.

### Embodiment 2

Corresponding to the SIP information analysis method described in the above embodiments, FIG. 4 illustrates a running environment schematic diagram of an SIP information analysis program according to an embodiment of the present application. For the convenience in description, only parts related to this embodiment are shown.

In this embodiment, the SIP information analysis program 400 is installed and runs in a server 40. The server 40 may include, but is not limited to, a memory 401 and a processor 402. FIG. 4 illustrates the server 40 with the components 401 and 402, but it should be understood that not all illustrated components are required to be implemented, and more or fewer components may be implemented instead.

The memory 401, in some embodiments, may be an internal storage unit of the server 40, such as a hard disk or a memory of the server 40. The memory 401, in some other embodiments, may also be an external storage device of the server 40, such as, a plug-in hard disk disposed on the server 40, a smart memory card (SMC), a secure digital (SD) card, and a flash card. Further, the memory 401 may also include both an internal storage unit of the terminal device 40 and an external storage device. The memory 401 is configured to store application software installed in the server 40 and various types of data, such as program code of the SIP information analysis program 400. The memory 401 may also be used to temporarily store data that has been output or is about to be output.

The processor 402, in some embodiments, may be a central processing unit (CPU), a microprocessor or other data processing chip for running program code stored in the memory 401 or processing data, such as executing the SIP information analysis program 400 and the like.

A display 403, in some embodiments, may be an LED display, a liquid crystal display, a touch liquid crystal display, an organic light-emitting diode (OLED) touch sensor, or the like. The components 401 and 402 of the server 40 are in communication with each other through a system bus.

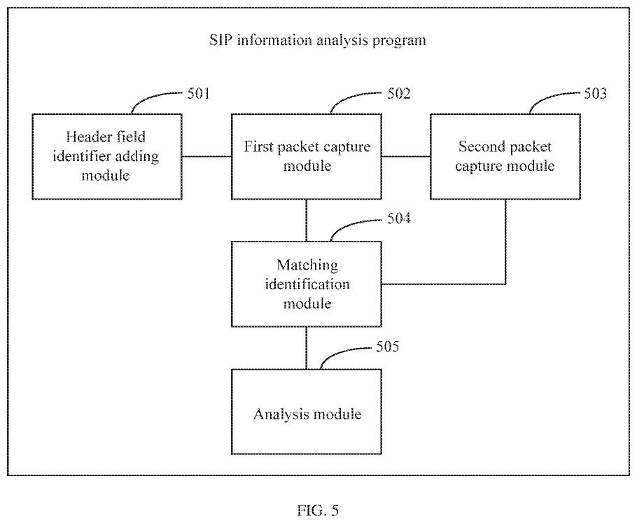

Referring to FIG. 5, FIG. 5 is a program module diagram of an SIP information analysis program 400 according to an embodiment of the present application. In this embodiment, the SIP information analysis program 400 may be divided into one or more modules, the one or more modules are stored in the memory 401 and executed by one or more processors (in this embodiment, the processor is the processor 402) to complete the present application. For example, in FIG. 5, the SIP information analysis program 400 can be divided into a header field identifier adding module 501, a first packet capture module 502, a second packet capture module 503, a matching identification module 504, and an analysis module 505. The modules referred to in the present application refer to a series of computer readable instruction segments that can perform a particular function, and are more suitable than a program to describe the execution process of the SIP information analysis program 400 in the server 40. The following description will specifically describe functions of the modules 501 to 505.

In this case, the header field identifier adding module 501 is configured to add a unique header field identifier to each of SIP messages so that each of the SIP messages can be uniquely identified.

The first packet capture module 502 is configured to perform packet capture on each of the SIP messages to obtain a first SIP message when the each of the SIP messages passes through an external network switch.

The second packet capture module 503 is configured to perform preset processing on each of the SIP messages before the each of the SIP messages passes through an internal network switch, and perform packet capture on each of the SIP messages again to obtain a second SIP message when the each of the SIP messages passes through the internal network switch.

The matching identification module 504 is configured to perform matching identification on each of the first SIP messages and each of the second SIP messages according to the header field identifier of each of the SIP messages, and determine a first SIP message and a second SIP message having the same header field identifier.

The analysis module 505 is configured to analyze the SIP messages according to the first SIP message and the second SIP message having the same header field identifier.

As an implementable mode, the analysis module 505 may include a comparison unit and a determination unit. The comparison unit is configured to compare the first SIP message and the second SIP message having the same header field identifier. The determination unit is configured to, when the sequence of the first SIP message is different from the sequence of the second SIP message, determine that a processing device performing the preset processing on the SIP message corresponding to the header field identifier is abnormal.

As another implementable mode, the analysis module 505 can include a comparison unit and a determination unit. The comparison unit is configured to compare the first SIP message and the second SIP message having the same header field identifier. The determination unit is configured to, when the first SIP message is subject to information loss as compared with the second SIP message, determine that a mobile terminal network is abnormal or a transit device is abnormal.

Optionally, the header field identifier adding module 501 is specifically configured to determine, according to the unique identifier of the terminal device that generates each of the SIP messages and the MAC address of each of the SIP messages, the header field identifier of each of the SIP messages, and add the header field identifier to the corresponding SIP message.

Further, the header field identifier adding module 501 is specifically configured to determine a hash value of each of the SIP messages by hash calculation according to the unique identifier of the terminal device that generates each of the SIP messages and the MAC address of each of the SIP messages, and take the hash value of the SIP message as the header field identifier of the SIP message.

Those skilled in the art can clearly understand that for convenience and brevity of description, only the division of each functional unit and module described above is exemplified. In practical applications, the allocation of the above functions may be completed by different functional units and modules according to needs. That is, the internal structure of the device is divided into different functional units or modules to perform all or part of the functions described above. Each functional unit and module in each embodiment may be integrated into one processing unit, or each unit may exist physically separately, or two or more units may be integrated into one unit. The above integrated unit can be implemented in the form of hardware or in the form of a software functional unit. In addition, the specific names of the respective functional units and modules are only for the purpose of facilitating mutual differentiation, and are not intended to limit the scope of protection of the present application. For the specific working process of the units and the modules in the foregoing system, a reference may be made to the corresponding process in the foregoing method embodiment, and details are not described herein again.

In the above embodiments, the descriptions of the various embodiments are different, and for the parts that are not detailed or described in a certain embodiment, see the related descriptions of other embodiments.

Those of ordinary skills in the art may be aware that the units and algorithm steps of the various examples described in combination with the embodiments disclosed herein can be implemented in electronic hardware or a combination of computer software and electronic hardware. Whether these functions are performed in hardware or software depends on the specific application and design constraints of the technical solution. A person skilled in the art can use different methods to implement the described functions for each particular application, but such implementation should not be considered to be beyond the scope of the present application.

In the embodiments provided by the present application, it should be understood that the disclosed apparatus/terminal device and method may be implemented in other manners. For example, the device/terminal device embodiment described above is merely illustrative. For example, the division of the module or unit is only a logical function division, and the actual implementation may have another division manner. For example, multiple units or components may be combined or integrated into another system, or some features may be omitted or not implemented. In addition, the mutual coupling or direct coupling or communication connection shown or discussed may be an indirect coupling or communication connection through some interfaces, devices or units, and may be electrical, mechanical or otherwise.

The units described as separate components may or may not be physically separated, and the components displayed as units may or may not be physical units, that is, the units and the components may be located in one place, or may be distributed to multiple network units. Some or all of the units may be selected according to actual needs to achieve the objective of the solution of the embodiment.

In addition, each functional unit in each embodiment of the present application may be integrated into one processing unit, or each unit may exist physically separately, or two or more units may be integrated into one unit. The above integrated unit can be implemented in the form of hardware or in the form of a software functional unit.

The integrated module/unit, if implemented in the form of a software functional unit and sold or used as an independent product, may be stored in a computer readable storage medium. Based on such understanding, the present application implements all or part of the processes in the method of the foregoing embodiment, and may also be implemented by commanding related hardware through computer readable instructions, which may be stored in a computer readable storage medium. The computer readable instructions, when executed by a processor, may implement the steps of the various method embodiments described above. The computer readable instructions include computer readable instruction code, which may be in the form of source code, in the form of object code, an executable file or some intermediate form or the like. The computer readable storage medium may include any entity or device capable of carrying the computer readable instruction code, a recording medium, a USB flash disk, a mobile hard disk, a magnetic disk, an optical disk, a computer memory, a read-only memory (ROM), random access memory (RAM), electrical carrier signals, telecommunications signals, software distribution media, etc. It should be noted that the content contained in the computer readable storage medium may be appropriately increased or decreased according to the requirements of legislation and patent practice in a jurisdiction. For example, in some jurisdictions, according to legislation and patent practice, the computer readable storage medium does not include electrical carrier signals and telecommunication signals.

The above embodiments are only used to illustrate the technical solutions of the present application, and are not intended to limit the technical solutions; although the present application has been described in detail with reference to the foregoing embodiments, those of ordinary skills in the art should understand that they can still modify the technical solutions recorded in each aforementioned embodiment, or perform equivalent substitutions on some of the technical features therein; and such modifications or substitutions do not make the essence of the corresponding technical solution depart from the spirit and scope of the technical solution of each embodiment of the present application, and should be included in the scope of protection of the present application.

1. A session initiation protocol (SIP) information analysis method, comprising:
adding a unique header field identifier to each of a plurality of SIP messages, such that each of the SIP messages is uniquely identifiable;
performing packet capture on each of the SIP messages to obtain a first SIP message when the each of the SIP messages passes through an external network switch;
performing preset processing on each of the SIP messages before each of the SIP messages passes through an internal network switch, and performing packet capture on each of the SIP messages again to obtain a second SIP message when the each of the SIP messages passes through the internal network switch;
performing matching identification on each of the first SIP messages and each of the second SIP messages according to the header field identifier of each of the SIP messages, to determine a first SIP message and a second SIP message having the same header field identifier; and
analyzing the SIP messages according to the first SIP message and the second SIP message having the same header field identifier.

2. The SIP information analysis method according to claim 1, wherein the step of analyzing the SIP messages according to the first SIP message and the second SIP message having the same header field identifier comprises:
comparing the first SIP message and the second SIP message having the same header field identifier; and
determining that a processing device performing the preset processing on the SIP message corresponding to the header field identifier is abnormal when the sequence of the first SIP message is different from the sequence of the second SIP message.

3. The SIP information analysis method according to claim 1, wherein the step of analyzing the SIP messages according to the first SIP message and the second SIP message having the same header field identifier comprises:
comparing the first SIP message and the second SIP message having the same header field identifier; and
determining that a mobile terminal network is abnormal or a transit device is abnormal when the first SIP message is subject to information loss as compared with the second SIP message.

4. The SIP information analysis method according to claim 1, wherein the step of adding a unique header field identifier to each of the SIP messages comprises:
determining, according to the unique identifier of a terminal device that generates each of the SIP messages and an MAC address of each of the SIP messages, the header field identifier of each of the SIP messages, and adding the header field identifier to the corresponding SIP message.

5. The SIP information analysis method according to claim 4, wherein the step of determining, according to the unique identifier of a terminal device that generates each of the SIP messages and an MAC address of each of the SIP messages, the header field identifier of each of the SIP messages comprises:
determining a hash value of each of the SIP messages by hash calculation according to the unique identifier of the terminal device that generates each of the SIP messages and the MAC address of each of the SIP messages, and taking the hash value of the SIP message as the header field identifier of the SIP message.

6-10. (canceled)

11. A server, comprising a memory and a processor, the memory being configured to store therein computer readable instructions executable on the processor, and when the processor implements the computer readable instructions, the following steps are implemented:
adding a unique header field identifier to each of a plurality of SIP messages, such that each of the SIP messages is uniquely identifiable;
performing packet capture on each of the SIP messages to obtain a first SIP message when the each of the SIP messages passes through an external network switch;
performing preset processing on each of the SIP messages before each of the SIP messages passes through an internal network switch, and performing packet capture on each of the SIP messages again to obtain a second SIP message when the each of the SIP messages passes through the internal network switch;
performing matching identification on each of the first SIP messages and each of the second SIP messages according to the header field identifier of each of the SIP messages, to determine a first SIP message and a second SIP message having the same header field identifier; and
analyzing the SIP messages according to the first SIP message and the second SIP message having the same header field identifier.

12. The server according to claim 11, wherein the step of analyzing the SIP messages according to the first SIP message and the second SIP message having the same header field identifier comprises:
comparing the first SIP message and the second SIP message having the same header field identifier, and determining that a processing device performing the preset processing on the SIP message corresponding to the header field identifier is abnormal when the sequence of the first SIP message is different from the sequence of the second SIP message.

13. The server according to claim 12, wherein the step of analyzing the SIP messages according to the first SIP message and the second SIP message having the same header field identifier comprises:
comparing the first SIP message and the second SIP message having the same header field identifier, and determining that a mobile terminal network is abnormal or a transit device is abnormal when the first SIP message is subject to information loss as compared with the second SIP message.

14. The server according to claim 12, wherein the step of adding a unique header field identifier to each of the SIP messages comprises:
determining, according to the unique identifier of a terminal device that generates each of the SIP messages and an MAC address of each of the SIP messages, the header field identifier of each of the SIP messages, and adding the header field identifier to the corresponding SIP message.

15. The server according to claim 14, wherein the step of determining, according to the unique identifier of a terminal device that generates each of the SIP messages and an MAC address of each of the SIP messages, the header field identifier of each of the SIP messages comprises:
determining a hash value of each of the SIP messages by hash calculation according to the unique identifier of the terminal device that generates each of the SIP messages and the MAC address of each of the SIP messages, and taking the hash value of the SIP message as the header field identifier of the SIP message.

16. A computer readable storage medium, having computer readable instructions stored therein, wherein when the computer readable instructions are executed by at least one processor, the following steps are implemented:
adding a unique header field identifier to each of a plurality of SIP messages, such that each of the SIP messages is uniquely identifiable;
performing packet capture on each of the SIP messages to obtain a first SIP message when the each of the SIP messages passes through an external network switch;
performing preset processing on each of the SIP messages before each of the SIP messages passes through an internal network switch, and performing packet capture on each of the SIP messages again to obtain a second SIP message when the each of the SIP messages passes through the internal network switch;
performing matching identification on each of the first SIP messages and each of the second SIP messages according to the header field identifier of each of the SIP messages, to determine a first SIP message and a second SIP message having the same header field identifier; and
analyzing the SIP messages according to the first SIP message and the second SIP message having the same header field identifier.

17. The computer readable storage medium according to claim 16, wherein the step of analyzing the SIP messages according to the first SIP message and the second SIP message having the same header field identifier comprises:
comparing the first SIP message and the second SIP message having the same header field identifier, and determining that a processing device performing the preset processing on the SIP message corresponding to the header field identifier is abnormal when the sequence of the first SIP message is different from the sequence of the second SIP message.

18. The computer readable storage medium according to claim 16, wherein the step of analyzing the SIP messages according to the first SIP message and the second SIP message having the same header field identifier comprises:
comparing the first SIP message and the second SIP message having the same header field identifier, and determining that a mobile terminal network is abnormal or a transit device is abnormal when the first SIP message is subject to information loss as compared with the second SIP message.

19. The computer readable storage medium according to claim 16, wherein the step of adding a unique header field identifier to each of the SIP messages comprises:
determining, according to the unique identifier of a terminal device that generates each of the SIP messages and an MAC address of each of the SIP messages, the header field identifier of each of the SIP messages, and adding the header field identifier to the corresponding SIP message.

20. The computer readable storage medium according to claim 19, wherein the step of determining, according to the unique identifier of a terminal device that generates each of the SIP messages and an MAC address of each of the SIP messages, the header field identifier of each of the SIP messages comprises:
determining a hash value of each of the SIP messages by hash calculation according to the unique identifier of the terminal device that generates each of the SIP messages and the MAC address of each of the SIP messages, and taking the hash value of the SIP message as the header field identifier of the SIP message.

21. The SIP information analysis method according to claim 2, wherein the step of adding a unique header field identifier to each of the SIP messages comprises:
determining, according to the unique identifier of a terminal device that generates each of the SIP messages and an MAC address of each of the SIP messages, the header field identifier of each of the SIP messages, and adding the header field identifier to the corresponding SIP message.

22. The SIP information analysis method according to claim 3, wherein the step of adding a unique header field identifier to each of the SIP messages comprises:
determining, according to the unique identifier of a terminal device that generates each of the SIP messages and an MAC address of each of the SIP messages, the header field identifier of each of the SIP messages, and adding the header field identifier to the corresponding SIP message.

23. The server according to claim 13, wherein the step of adding a unique header field identifier to each of the SIP messages comprises:
determining, according to the unique identifier of a terminal device that generates each of the SIP messages and an MAC address of each of the SIP messages, the header field identifier of each of the SIP messages, and adding the header field identifier to the corresponding SIP message.

24. The computer readable storage medium according to claim 17, wherein the step of adding a unique header field identifier to each of the SIP messages comprises:
determining, according to the unique identifier of a terminal device that generates each of the SIP messages and an MAC address of each of the SIP messages, the header field identifier of each of the SIP messages, and adding the header field identifier to the corresponding SIP message.

25. The computer readable storage medium according to claim 18, wherein the step of adding a unique header field identifier to each of the SIP messages comprises:
determining, according to the unique identifier of a terminal device that generates each of the SIP messages and an MAC address of each of the SIP messages, the header field identifier of each of the SIP messages, and adding the header field identifier to the corresponding SIP message.
